(19) United States
(12) Patent Application Publication
(10) Pub. No.: US 2024/0260798 A1
(43) Pub. Date: Aug. 8, 2024

(54) HANDHELD BLOWER APPARATUS

(71) Applicant: Andreas Stihl AG & Co. KG, Waiblingen (DE)

(72) Inventors: Felix Oberhofer, Stuttgart (DE); Florian von Krane, Kirchberg (DE); Markus Zauner, Fellbach (DE); Thilo Stuerzel, Remshalden (DE); Alexander Eichner, Kirchheim unter Teck (DE); Markus Koenig, Leinfelden-Echterdingen (DE)

(21) Appl. No.: 18/430,437

(22) Filed: Feb. 1, 2024

(30) Foreign Application Priority Data
Feb. 2, 2023 (EP) 23154742.3

(51) Int. Cl. A47L 5/14; A01G 20/47; A47L 9/24; A47L 9/28; A47L 9/32

(52) U.S. Cl. CPC A47L 5/14; A47L 9/248; A47L 9/2884; A47L 9/322; A01G 20/47

(57) ABSTRACT

A handheld blower apparatus includes a handle, a blower tube, a blower unit arranged in the tube, and has an intake opening and a discharge opening. The blower unit has a blower wheel rotationally driveable about a rotational axis aligned in the direction of an air flow flowing out from the wheel during operation. The wheel is driven by an electric motor supplied with energy by a battery. A handle opening extends between the handle and tube. A central plane intersects the handle and battery and contains the rotational axis. A compact, ergonomic arrangement is achieved when the battery and the handle are arranged on opposite sides of the tube and the top side of the tube, when viewed in the direction perpendicular to the central plane, has an indentation extending over at least 50% of the length, measured parallel to the rotational axis, of the handle opening.

### CROSS-REFERENCE TO RELATED APPLICATIONS

This application claims priority of European patent application Ser. No. 23/154,742.3, filed Feb. 2, 2023, the entire content of which is incorporated herein by reference.

### BACKGROUND

U.S. Pat. No. 9,603,497 B2 discloses a handheld blower apparatus, the drive motor of which is driven by a battery. The battery is arranged below a handle of the blower apparatus. The blower tube ends in front of the handle and the battery with respect to the longitudinal center axis of the blower tube.

### SUMMARY

It is an object of the disclosure to provide a handheld blower apparatus which has an advantageous configuration.

This object is, for example, achieved by a handheld blower apparatus including: a handle for guiding the blower apparatus during operation; a blower tube; a blower unit arranged in the blower tube; wherein the blower apparatus defines an intake opening and a discharge opening; the blower unit having at least one blower wheel configured to be driven rotationally about a rotational axis, the rotational axis being aligned in a direction of an air flow flowing out from the at least one blower wheel during operation; an electric motor configured to drive the at least one blower wheel; a battery configured to supply the electric motor with energy; wherein the battery and the handle are arranged on opposite sides of the blower tube and a handle opening extends between the handle and the blower tube; the blower apparatus defining a central plane, which intersects the handle and the battery and which contains the rotational axis of the blower wheel; the handle opening having a length (g) measured parallel to the rotational axis; and, the blower tube having a top side which, when viewed in a direction perpendicular to the central plane, has an indentation extending over at least 50% of the length (g).

Owing to the fact that the battery and handle are arranged on opposite sides of the blower tube, a compact configuration is produced. The blower tube is advantageously inserted between the handle and the battery. This allows the intake of blowing air from an area on the rear side of the apparatus, that is, on the side of the handle and battery that faces away from the discharge opening. This avoids deflections of the blowing air flow. A handle opening extends between the handle and the blower tube. The blower apparatus has a central plane, which intersects the handle and the battery and which contains the rotational axis of the blower wheel. The top-side side of the blower tube, when viewed in the direction perpendicular to the central plane, has an indentation. The blower tube is therefore advantageously narrower because of the indentation on the top-side side adjacent to the handle opening. This easily allows space for the user's hand and allows the handle to be arranged at a comparatively small distance from the rotational axis of the blower wheel. In particular, the indentation extends over at least 50% of the length, measured parallel to the rotational axis, of the handle opening. A compact configuration is thereby produced. The forces arising during operation when the blower apparatus is pivoted about a horizontally running axis can be kept comparatively small.

Advantageously, in at least one intersecting plane perpendicular to the rotational axis of the blower wheel, the intersecting plane intersecting the handle opening, the distance of the rotational axis of the blower unit from a top-side side of the blower tube running adjacent to the handle opening is smaller than the distance of the rotational axis from an opposite bottom side of the blower tube. The rotational axis of the blower wheel therefore preferably does not run centrally through the blower tube in the intersecting plane. The blower tube is advantageously asymmetrical with respect to a plane containing the rotational axis and running perpendicular to the central plane. The bottom side of the blower tube runs in particular adjacent to the battery.

The top-side side of the blower tube is the area of the blower tube which is at a comparatively small distance from the handle opening, and the bottom side of the blower tube is the area of the blower tube which is at a greater distance from the handle opening. In the usual operating position of the blower apparatus, the bottom side of the blower tube runs below the top-side side of the blower tube.

The rotational axis of the blower wheel is aligned in the direction of an air flow flowing out from the blower wheel during operation. The rotational axis of the blower wheel is aligned in particular in the direction of a longitudinal center axis of the blower tube. The blower wheel is advantageously an axial blower wheel or a diagonal blower wheel. In particular, the blower wheel is not configured as a radial blower wheel.

The battery is advantageously replaceable.

The central plane is advantageously perpendicular in a operating position and the handle is arranged above the blower tube and the battery is arranged below the blower tube. The operating position advantageously corresponds to a normal operating position of the blower apparatus during operation. In the normal operating position, the operator holds the blower apparatus by the handle and the blower tube runs below the handle.

The term “blower tube” refers here in particular to the section of the tube through which operating air is conveyed during operation, the section being fixedly connected to a housing of the blower apparatus and not being intended to be removed by an operator during normal operation. The blower tube may be formed integrally with the housing of the blower apparatus or may be connected to the housing via connectors which cannot be released without a tool. Different nozzle attachments can usually be fixed by the operator to the discharge opening from the blower tube. The nozzle attachments can usually be mounted and removed without a tool, for example via bayonet connections or snap-action connections.

In order to achieve a compact configuration of the blower apparatus, it is advantageously provided that, in at least one intersecting plane, the intersecting plane intersecting the handle opening and lying perpendicular to the rotational axis of the blower wheel, a width, measured perpendicular to the central plane, of the blower tube is greater than the height of the blower tube in the intersecting plane. Thus, the blower tube does not have a round cross section in the at least one intersecting plane. This makes it easy to achieve a compact configuration of the blower apparatus. Owing to the reduced height of the blower tube, the handle opening and battery, and especially the handle and battery, can move closer together, and therefore the overall height of the blower apparatus in this area can be reduced. The width of the blower tube in the intersecting plane is advantageously at least 110%, in particular at least 130%, preferably at least 150%, of the height of the blower tube in the intersecting plane. The width and the height of the blower tube are advantageously the internal dimensions of the blower tube. The height and width of the external dimensions of the blower tube are advantageously selected accordingly. Advantageously, the rotational axis of the blower unit runs, in the region of the blower tube in which the width of the blower tube is greater than the height of the blower tube, not centrally with respect to the height of the blower tube.

For the purposes of the present application, the rotational axis of the blower wheel is a straight line in space. The rotational axis is not limited to the position of the blower wheel, but rather is extended infinitely on both sides of the blower wheel. Details defining dimensions with respect to the rotational axis therefore only indicate a distance from an infinitely long axis in space, but not a position with respect to the longitudinal direction of the rotational axis.

The battery advantageously has a longitudinal axis. The longitudinal axis of the battery advantageously runs parallel to the central plane. Preferably, the longitudinal axis of the battery lies in the central plane. The battery is preferably approximately cuboid or cylindrical. An oval shape of the battery may also be provided. The longitudinal axis of the battery runs between opposite outer sides of the battery perpendicularly through the opposite sides of the battery which are at the greatest distance from each other. The battery is thus oriented in the direction of the central plane.

The blower tube advantageously runs in angled or bent form in the longitudinal section between the handle and the discharge opening. This makes it possible to align the discharge opening from the blower tube in such a way that the extension of the center axis of the discharge opening intersects the handle. As a result, recoil forces of the discharged air exert only a small pivot torque, if any at all, about the handle. This means that the operator has to use less force to hold the blower apparatus during operation. Advantageously, when viewed in the direction perpendicular to the central plane, the longitudinal center axis of the blower tube in the discharge opening encloses an angle, which is from 120° to 175°, in particular from 140° to 170°, with the rotational axis of the blower wheel. The longitudinal center axis of the blower tube advantageously corresponds to the main flow direction of an air flow conveyed through the blower tube. The longitudinal center axis of the blower tube is advantageously a curve and not a straight line. The inclination or curvature of the blower tube preferably starts downstream of the at least one blower wheel. The blower wheels and guide wheels of the blower unit are advantageously arranged in a section of the blower tube which runs rectilinearly and preferably has a round cross section. This means that a blower unit with a simple configuration can be used. The distance of the top side of the blower tube from the rotational axis at the intake opening is advantageously greater than the distance of the bottom side of the blower tube from the rotational axis. The blower tube accordingly opens at the intake opening on the top side. This allows a sufficiently large intake surface to be realized in a simple way. The battery is arranged on the opposite bottom side of the blower tube. In this region of the blower tube there is advantageously sufficient installation space to be able to insert the battery from the rear side of the blower apparatus, that is, from the side to which the intake opening also opens.

Advantageously, the battery has a longitudinal axis which encloses an angle of more than 2° with the rotational axis of the blower wheel. The angle opens in the blower tube counter to the flow direction. The battery is therefore inclined with respect to the rotational axis of the blower wheel, preferably by a comparatively small angle. This allows sufficient clearance to be created for inserting the battery from the rear side of the blower apparatus and at the same time a sufficiently large intake opening to be realized.

Advantageously, the battery is held on a housing of the blower apparatus via a mechanical locking unit. Advantageously, the locking unit is arranged at least partially between the battery and the blower tube. In order to achieve a compact configuration, it is advantageously provided that the blower tube has a bulge into which an actuating element of the locking unit projects. This creates a compact overall arrangement. The bulge preferably extends as far as the intake opening of the blower tube. The actuating element is advantageously arranged and configured in such a way that it is easily accessible from the side of the blower apparatus at which the intake opening intakes air. The actuating element is advantageously accessible from the side of the blower apparatus from which the battery is removed. This makes it easy to remove the battery.

In order to enable ergonomic operation of the blower apparatus, the weight distribution of the components of the blower apparatus is advantageously selected such that low forces are produced when working with the blower apparatus, especially when pivoting the blower apparatus about a vertical axis. Advantageously, even the forces produced by the recoil of the air escaping from the blower tube are low for the operator. Such an arrangement is achieved when the battery and the electric motor of the blower wheel are arranged in such a way that the center of gravity of the arrangement lies below the handle at a desired operational position of the blower tube and of the discharge opening.

In order to achieve a compact configuration of the blower apparatus, it is advantageously provided that the battery is at a distance, measured parallel to the rotational axis, from the discharge opening, the distance being greater than the distance, measured in the same direction, of the handle opening from the discharge opening. The handle opening therefore begins closer to the discharge opening than the battery, with respect to the direction of the rotational axis.

The electric motor advantageously can be at a distance, measured parallel to the rotational axis of the blower wheel, from the discharge opening, the distance being smaller than a distance, measured in the same direction, of the handle opening from the discharge opening. The electric motor is therefore arranged closer to the discharge opening with respect to the rotational axis of the blower wheel than the end of the handle opening which is close to the discharge opening. Particularly preferably, the electric motor is arranged completely downstream of the handle opening. With respect to the rotational axis of the blower wheel, the electric motor therefore ends at a distance from the discharge opening, the distance being smaller than the distance of the handle opening from the discharge opening.

All distances from the same point of the discharge opening are measured at the discharge opening.

Advantageously, the battery does not protrude beyond the intake opening with respect to the rotational axis of the at least one blower wheel. The largest distance, measured parallel to the rotational axis, of the intake opening from the discharge opening is advantageously greater than the distance, measured in the same direction, of the end of the battery, which is remote from the intake opening, from the discharge opening. The distance between the intake opening and the discharge opening may be slightly greater than the distance between the end of the battery, which is remote from the intake opening, and the discharge opening. The largest distance of the discharge opening from the intake opening is measured between the region of the intake opening, which is remote from the intake opening, and the discharge opening.

In order to prevent unintended clogging of the intake opening and to be able to provide a sufficiently large intake surface even in the event of minor contaminations, it is advantageously provided that the intake opening has a first end-side intake area and a second intake area on the circumference of the blower tube. If one of the intake openings is partially covered, for example, by leaves or the operator's clothing, an adequate intake of blowing air can still be ensured via the other intake area.

The wall of an intake section of the blower tube, which extends between the intake opening and the blower unit, advantageously has at least one opening, which connects the interior of the blower tube to a cavity formed behind the wall. The at least one opening forms a Helmholtz resonator with the cavity, which can significantly reduce the production of noise in the intake section of the blower tube. Preferably, a multiplicity of openings are provided to achieve an effective reduction in noise.

The electric motor is advantageously arranged in the blower tube. A compact configuration is produced when the electric motor is arranged in an interior of the blower unit.

Advantageously, the maximum distance, measured parallel to the rotational axis of the blower wheel, of the side of the electric motor, which is remote from the discharge opening, is not more than 5 cm larger, preferably smaller, than the distance, measured in the same direction, of the handle opening from the discharge opening. The electric motor is therefore located at most slightly behind the end of the handle opening close to the discharge opening. Preferably, the electric motor is located before the start of the handle opening. This allows a compact arrangement and favorable weight distribution of the blower apparatus to be achieved. In the present application, the terms “front” and “behind” refer to the flow direction in the blower tube, which extends from the intake opening located behind to the discharge opening located at the front. A first position which is arranged further away from the discharge opening in the flow direction than a second position is referred to as behind the second position.

The distance, measured parallel to the rotational axis of the blower wheel, of the side of the electric motor, which is remote from the discharge opening, is preferably smaller than the distance, measured in the same direction, of the battery from the discharge opening.

### BRIEF DESCRIPTION OF DRAWINGS

The invention will now be described with reference to the drawings wherein:

FIG. 1 shows a side view of a handheld blower apparatus;

FIG. 2 shows a top view of the blower apparatus from FIG. 1 in the direction of the arrow II in FIG. 1;

FIG. 3 shows a partially sectioned side view of the blower apparatus from FIGS. 1 and 2;

FIG. 4 shows a schematic enlarged illustration of the arrangement of the components of the blower apparatus,

FIG. 5 shows a section along the line V-V in FIG. 4;

FIG. 6 shows a side view in the direction of the arrow VI in FIG. 3;

FIG. 7 shows the illustration from FIG. 6 with intake grille removed; and,

FIG. 8 shows a sectional illustration of an enlarged detail of the region VIII in FIG. 3, which shows the locking unit of the blower apparatus.

### DETAILED DESCRIPTION

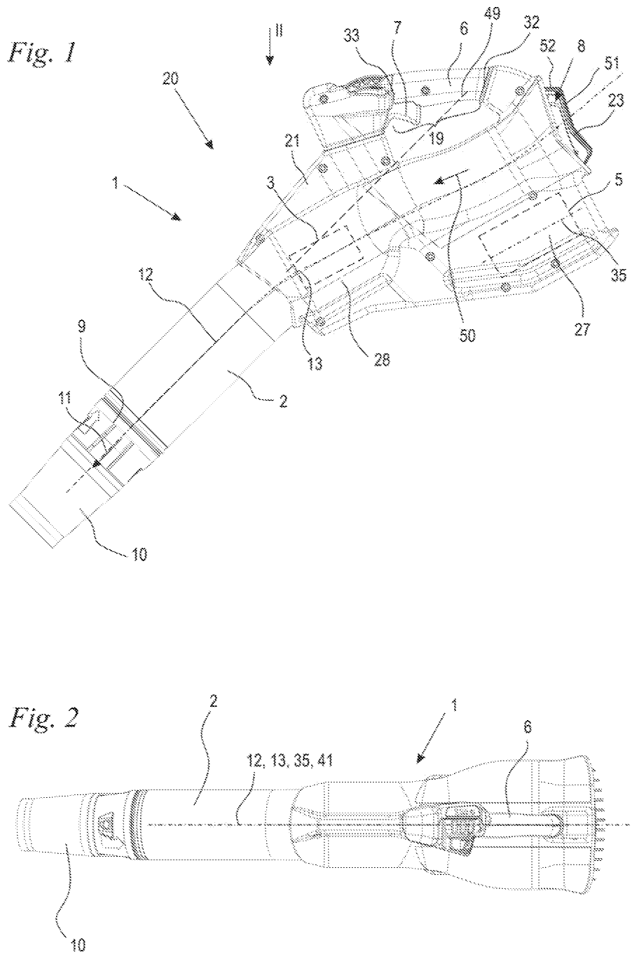

FIG. 1 shows a handheld blower apparatus 1 in a side view. The blower apparatus 1 includes a blower tube 2. The blower tube 2 has an intake opening 8 and a discharge opening 9. Intake opening 8 and discharge opening 9 are formed on opposite end sides of the blower tube 2. In the embodiment, the blower tube 2 forms part of the housing 21 of the blower apparatus 1. The blower apparatus 1 has a handle 6. In the embodiment, the handle 6 forms part of the housing 21. In the embodiment, an operator lever 7 for activating a blower unit, which is described in more detail below, of the blower apparatus 1 is arranged on the handle 6. Advantageously, further operator elements which can interact in a suitable manner with the operator lever 7 are provided.

The handle 6 has a handle region 19, at which an operator can grip the handle 6. In the handle region 19, the handle 6 is preferably formed with a rounded cross section that is easy for the operator to grip. The handle region 19 has a first end 32 and a second end 33. The hand of an operator should be arranged on the handle 6 such that index finger and thumb are positioned closer to the second end 33 and the little finger side of the hand closer to the first end 32.

FIG. 1 shows the blower apparatus 1 in a normal operating position 20 for the operation. In this operating position 20, the discharge opening 9 is directed obliquely with respect to the ground. A discharge opening 11 from the blower tube 2 faces obliquely with respect to the ground. A nozzle 10 is arranged at the discharge opening 9 on the blower tube 2 in the embodiment. The discharge opening 9 is the outlet opening from the part of the blower tube 2 which is held nonreleasably on the housing 21 or is formed integrally with the housing 2. Depending on the work task at hand, different nozzles 10 may be arranged on the discharge opening 9 of the blower tube 2.

As shown in FIG. 1, an intake grille 23 is arranged on the intake opening 8. The intake grille 23 is used to prevent the entry of relatively large contaminations into the blower tube 2. In the embodiment, the intake grille 23 has different intake areas, namely a first, end-side intake area 51 and a second, circumferential-side intake area 52. Other or further intake areas may also be advantageous. The intake areas 51 and 52 are surfaces that are spanned by the intake grille 23. The intake areas 51 and 52 are angled with respect to each other in the embodiment. Even if one of the intake areas 51 or 52 is closed by sucked-up parts, such as leaves, an operator's clothing or the like, working air can still be sucked up through the other intake area.

FIG. 1 schematically also shows the arrangement of components of the blower apparatus 1. A blower unit 3 is arranged in the blower tube 2. The region of the housing 21 surrounding the blower unit 3 is hereinafter referred to as blower housing 28. The blower apparatus 1 also has a battery 5, which is arranged in a battery housing. The battery 5 has a longitudinal axis 35.

As shown in FIG. 1, the handle 6 and the battery 5 are arranged on opposite sides of the blower tube 2. The blower tube 2 is inserted between handle 6 and battery 5. The handle 6 is arranged above the blower tube 2 in the operating position 20 shown in FIG. 1. The battery 5 is arranged below the blower tube 2 in the operating position 20 shown in FIG. 1.

The blower tube 2 has a longitudinal center axis 12. The longitudinal center axis 12 connects the area centers of gravity of sections through the blower tube 2 perpendicular to a flow direction 50 in the blower tube 2. As shown in FIG. 1, the longitudinal center axis 12 of the blower tube 2 is bent in one region in the embodiment. Even a kinked course of the blower tube 2 may be advantageous. The discharge direction 11 is therefore inclined more greatly with respect to the ground than in the case of a rectilinear profile of the longitudinal center axis 12. In FIG. 1, the longitudinal center axis 12 in the discharge opening 9 is shown extended with a chain-dotted line in the direction of the handle 6. The extension 49 shown of the longitudinal center axis 12 in the discharge opening 9 intersects the handle 6 between its first end 32 and its second end 33, as shown in FIG. 1. A recoil force, which is produced by the working air exiting through the discharge opening 9, therefore passes through the handle 6. As a result, the pivot torque that such a force exerts on the handle 6 is comparatively low.

As shown in FIG. 2, the blower apparatus 1 has a central plane 41. In the top view shown in FIG. 2, the longitudinal axis 35 of the battery 5 lies in the central plane 41. The central plane 41 advantageously intersects the battery 5 in the middle. However, it may also be provided that the longitudinal axis 35 runs parallel to the central plane 41 at a distance therefrom. In the embodiment, the longitudinal center axis 12 also runs in the central plane 41. The blower unit 3 has at least one blower wheel 14 shown in FIG. 7. The blower wheel 14 is preferably an axial or a diagonal blower wheel. The blower unit 3 is advantageously an axial blower. However, the blower unit 3 may also be a diagonal blower. The blower wheel 14 is rotationally driven about a rotational axis 13 shown schematically in FIG. 1. As shown in FIG. 2, the rotational axis 13 of the at least one blower wheel 14 lies in the central plane 41. The central plane 41 is a plane of the blower apparatus 1 that intersects the handle 6 and the battery 5 and that contains the rotational axis 13 of the blower wheel 14. The blower apparatus 1 may therefore have a plurality of central planes 41. Preferably, the central plane 41 intersects the handle 6 in the middle.

During operation, the blower apparatus 1 conveys an air flow through the blower tube 2 in the flow direction 50. The rotational axis 13 of the at least one blower wheel 14 is aligned in the direction of the air flow flowing out from the blower wheel 14 during operation. On the downstream side of the blower wheel 14, the rotational axis 13 runs in the flow direction 50.

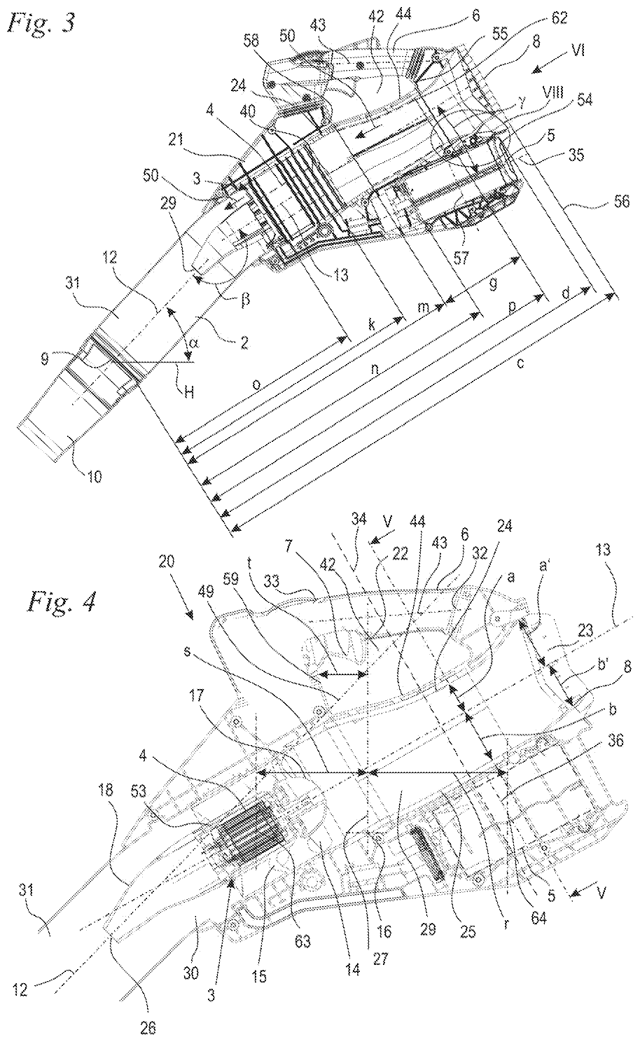

FIG. 3 shows a partially sectioned side view of the blower apparatus 1. As shown in FIG. 3, the blower unit 3 is arranged in the blower tube 2. The blower unit 3 is advantageously arranged, in each intersecting plane perpendicular to the rotational axis 13, in the middle of the blower tube 2. The rotational axis 13 of the blower wheel 14 advantageously coincides with the longitudinal center axis 12 in the region of the blower unit 3 in which an electric motor 4 shown in FIG. 4 is arranged. As shown in FIG. 4, an intake guide element 17 is arranged at the entry into the blower unit 3. A blower wheel 14 is formed on the outer circumference of the intake guide element 17. The blower wheel 14—in the embodiment with the inlet guide element 17—is driven rotationally about the rotational axis 13 by the electric motor 4. A guide wheel 15, which does not concomitantly rotate during operation, is arranged downstream of the blower wheel 14.

As shown in FIG. 4, the electric motor 4 is arranged inside the guide wheel 15. The electric motor 4 is arranged in a cylindrical housing part 53. The guide wheel 15 extends on the outer circumference of the housing part 53. During operation, air is advantageously sucked into the housing part 53 for cooling the electric motor 4. Downstream of the guide element 15, the housing part 53 in the embodiment merges into a discharge guide element 18. At the downstream end side of the discharge guide element 18 an opening is formed, via which cooling air is advantageously sucked into the housing part 53 during operation in order to cool the electric motor 4. Alternatively or in addition, different cooling of the electric motor 4 may be advantageous.

In the embodiment, the blower unit 3 is configured as a single-stage blower. In the embodiment, the blower unit 3 is an axial blower. A plurality of blower wheels, that is, a plurality of blower stages, may also be advantageous for the blower unit 3. Instead of being configured as axial blower wheels, the blower wheels 14 may also be configured as diagonal blower wheels.

As shown in FIG. 3, the blower unit 3 in the blower tube 2 conveys the working air from the intake opening 8 to the discharge opening 9 in the flow direction 50. The handle 6 has a longitudinal center axis 43. Between the handle 6 and the blower tube 2, a handle opening 42 is formed, in which an operator's hand can engage during operation. In the region adjacent to the handle opening 42, the blower tube 2 in the embodiment has an indentation 44. The indentation 44 is in the form of a flattened portion on a top side 24 of the blower tube 2. The indentation 44 extends over at least 50%, in particular over at least 70%, of a length g, measured parallel to the rotational axis 13, of the handle opening 42.

In FIG. 3, the distances of different elements of the blower apparatus 1 from the discharge opening 9 are shown. All of the distances are measured parallel to the rotational axis 13 of the at least one blower wheel 14 (FIG. 4). All of the distances are measured with respect to the same point of the discharge opening 9. Any point of the discharge opening 9 can serve as a reference point for measuring the distances. The electric motor 4 shown with a dashed line in FIG. 3 is at a distance o from the discharge opening 9. The side 40 of the electric motor 4 facing away from the discharge opening 9 is at a distance k from the discharge opening 9. The handle opening 42 is at a distance m from the discharge opening 9. The distance k is measured to the end 58 of the handle opening 42 close to the discharge opening 9. In the embodiment, the distance m is greater than the distance k. The distance m is greater than the distance o. If the distance m is greater than the distance k, the electric motor 4 is located completely in front of the handle opening 42 with respect to the rotational axis 13.

The battery 5 is at a distance n from the discharge opening 9. In the embodiment, the distance n is greater than the distance m and greater than the distances o and k. The battery 5 is therefore located behind the end 58 of the handle opening 13 which is close to the discharge opening 9, with respect to the rotational axis 13. As shown in FIG. 3, handle opening 42 and battery 5 overlap with respect to the rotational axis 13. There are therefore a plurality of intersecting planes perpendicular to the rotational axis 13, which intersect both the handle opening 42 and the battery 5. Preferably, battery 5 and handle opening 42 overlap over at least 30%, in particular at least 50%, of the length g of the handle opening 42. The length g is measured parallel to the rotational axis 13.

The handle opening 42 has an end 55 which is remote from the discharge opening. The end 55 is at a distance p, which is measured parallel to the rotational axis 13, from the discharge opening 9. The battery 5 has a side 54 facing away from the discharge opening 9. The side 54 of the battery 5 is at a distance d from the discharge opening 9. The distance d is greater than the distance p of the end 55 of the handle opening 42 which is remote from the discharge opening 9.

The intake opening 8 is at a largest distance c from the discharge opening 9. The distance c is measured with respect to the region of the intake opening 8 which is remote from the discharge opening 9. The largest distance c is greater than the distances d, p, n, m, k and o. In the embodiment, the intake opening 9 forms the rear side of the blower apparatus 1, which is remote from the discharge opening 9. An imaginary plane 56 which runs perpendicularly to the rotational axis 13 and lies on the intake opening 8 and with respect to which the greatest distance c is measured does not intersect any further components of the blower apparatus 8.

As shown in FIG. 3, the longitudinal center axis 12 of the blower tube 2 is inclined by an angle α to a horizontal H in the usual operating position 20 shown in FIG. 3. The angle α is advantageously from 25° to 40°. The longitudinal center axis 12 in the discharge opening 9 encloses an angle β with the rotational axis 13 of the at least one blower wheel 14 (FIG. 4). The angle β is less than 180°. Preferably, the angle β is between 120° and 170°, in particular between 150° and 170°. The angle β is measured in the viewing direction perpendicular to the central plane 41. The angle β is measured in the viewing direction perpendicular to the central plane 41 in particular in the region enclosed by the longitudinal center axis 12 and the rotational axis 13, which region in the usual operating position 20 includes the ground below the blower apparatus 1 and the battery 5.

The longitudinal axis 35 of the battery 5 encloses an angle γ, which is advantageously at least 2°, with the rotational axis 13 in the viewing direction perpendicular to the central plane 41. The angle β is from 120° to 175°, especially from 140° to 170°. The angle γ opens in the blower tube 2 counter to the flow direction 50. The viewing direction perpendicular to the central plane 41 corresponds to the view shown in FIG. 2.

The blower tube 2 has an intake section 29, a blower section 30 and a discharge section 31, which are shown in FIG. 4. The blower section 30 adjoins the intake section 29, and the discharge section 31 adjoins the blower section 30. The intake section 29 extends from the intake opening 8 as far as the entry into the blower unit 3. In the embodiment, the entry into the blower unit 3 is formed on the upstream side of the intake guide element 17. The blower section 30 extends from the entry into the blower unit 3 as far as the opening 26, that is, as far as the downstream end of the blower unit 3. The discharge section 31, which is also shown in FIG. 3, extends from the blower section 30 as far as the discharge opening 9. As shown in FIGS. 3 and 4, the bend or curvature of the blower tube 2 in the embodiment runs completely in the blower section 30, specifically in the region of the blower section 30 in which the discharge guide element 18 is arranged. However, a different position of the curved or bent region of the blower tube 2 may also be advantageous.

To reduce the production of noise during operation, the blower tube 2, in particular the intake section 29 of the blower tube 2, may have a lining 62. This is shown schematically with a dashed line in FIG. 3. The lining 62 may preferably be a foamed plastic. Particularly preferably, the lining 62 is at least partially arranged in the region of the blower tube 2 that is arranged below the handle opening 42 in the usual operating position 20.

The blower apparatus 1 has a center of gravity 16, which is shown schematically in FIG. 4. In the operating position 20, the center of gravity 16 lies below the handle region 19. The blower apparatus 1 swings out in such a way that the center of gravity 16 lies below the handle region 19 when the blower apparatus 1 is supported from below only by way of the handle 6. The longitudinal center axis 43 of the handle 6 preferably lies approximately horizontally in the operating position 20. The longitudinal center axis 43 preferably encloses an angle, which is smaller than 20°, in particular smaller than 10°, with the horizontal H (FIG. 3) in the operating position 20.

The center of gravity 16 lies below a grip point 22 of the handle 6, the grip point being located on the handle 6 in the vicinity of the operator lever 7. An operator's hand is usually arranged in the grip point 22. The extension 49 of the longitudinal center axis 12 in the discharge opening 9 intersects the handle 6 preferably adjacent to the grip point 22 or in the grip point 22. The end 58 of the handle opening 42 located close to the discharge opening 9 forms a hand stop 59. An operator's index finger may lie against the hand stop 59 when the operator lever 7 is actuated. Advantageously, the distance t of the hand stop 59, measured in the horizontal direction in the usual operating position 20, from the center of gravity 16 is comparatively small. Advantageously, the distance t is less than 8 cm, in particular about 4 cm to 5 cm. An axis 27, which runs vertically and through the center of gravity 16 in the usual operating position 20, preferably runs, in the operator's usual hand position, through the region of the operator's middle finger and ring finger. This means that forces acting during operation can be absorbed ergonomically by the operator. Forces that act about the axis 27 when the blower apparatus 1 is pivoted are comparatively low. Preferably, the operator lever 7 is dimensioned such that only an operator's index finger actuates the operator lever 7, and an operator's middle finger and ring finger clasp the handle 6. The region of the operator's middle finger and ring finger preferably defines the grip point 22.

The electric motor 4 of the blower unit 3 has a center of gravity 63. The battery 5 has a center of gravity 64. Preferably, the center of gravity 63 and/or the center of gravity 64 are/is arranged in the usual operating position 20 in the horizontal direction as close as possible to the center of gravity 16 of the blower apparatus 1. As a result, the forces produced when the blower apparatus 1 is pivoted about the axis 27 in the operating position 20 are comparatively small. The center of gravity 63 of the electric motor 4 is at a distance s, measured in the horizontal direction, from the center of gravity 16 in the usual operating position 20. The distance s is preferably less than 20 cm, in particular less than 17 cm, preferably less than 15 cm. The center of gravity 64 of the battery 5 is at a distance r, measured in the horizontal direction, from the center of gravity 16 in the usual operating position 20. In the embodiment, the distance r is greater than the distance s. In an advantageous alternative configuration, the distance r is smaller than the distance s. The distance r is advantageously less than 20 cm, in particular less than 17 cm, preferably less than 15 cm.

As shown in FIG. 4, the indentation 44 in the embodiment extends over the entire length of the handle opening 42. As shown in FIG. 4, a top side 24 of the blower tube 2 at the handle opening 42 is at a distance a from the rotational axis 13. An opposite bottom side 25 of the blower tube 2 is at a distance b from the rotational axis 13. The distance b is greater than the distance a. The bottom side 25 of the blower tube 2 delimits the blower tube 2 toward the battery 5. At the intake opening 8, the top side 24 is at a distance a′ from the rotational axis 13. The bottom side 25 is at a distance b′ from the rotational axis 13. The distance a′ at the intake opening 8 is greater than the distance b′. The top side 24 is advantageously the side of the blower tube 2 which is arranged at the top in the operating position 20, and the bottom side 25 is advantageously the side of the blower tube 2 which is arranged at the bottom in the operating position 20.

A plane 34, in which the distance a from the rotational axis 13 to the top side 24 is minimal, runs through the handle opening 42. The plane 34 is advantageously at a distance both from the first end 32 and from the second end 33 of the handle 6, which distance corresponds to at least 20% of the length g of the handle opening 42.

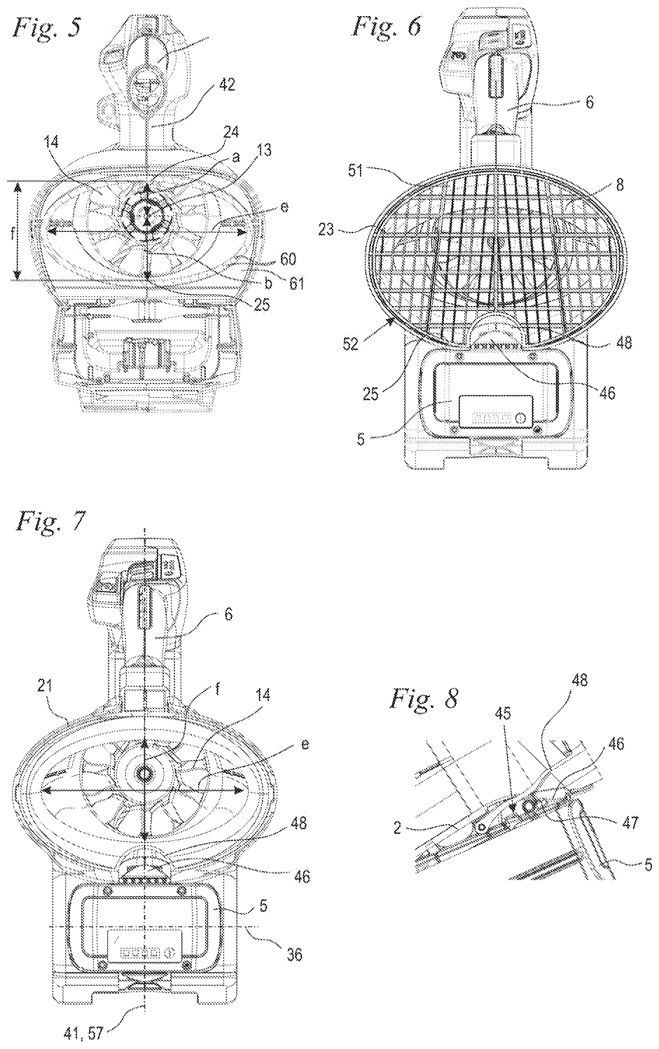

FIG. 5 shows a section through the blower tube 2 perpendicular to the rotational axis 13 of the blower wheel 14 in the region of the handle opening 42. As shown in FIG. 5, a width e, described in more detail below, of the blower tube 2 is greater than a height f, described in more detail below. As the sectional illustration also shows, the distance a of the top side 24 of the blower tube 2 at the handle opening 42 from the rotational axis 13 is smaller than the distance b of the bottom side 25 of the blower tube 2 from the rotational axis 13. As FIG. 5 also shows, in the sectional plane shown, the blower tube 2 has a cross section which is not round, in the embodiment an approximately oval cross section.

FIG. 6 shows a view of the intake opening 8 with the intake grille 23. As shown in FIG. 6, the first intake area 51 is formed at the intake grille 23 on the end side of the blower tube 2 (FIG. 3). FIG. 6 also shows the arrangement of handle 6 and battery 5 on opposite sides of the blower tube 2. As FIG. 6 also shows, at the bottom side 25 of the blower tube 2 a bulge 48 is formed, into which an actuating element 46 for releasing and locking the battery 5 projects.

As shown in FIG. 7, the battery 5 has a transverse axis 36 which is aligned perpendicular to the central plane 41 and perpendicular to the longitudinal axis 35. In the embodiment, the battery 5 has an approximately cuboidal shape. The longitudinal axis 35 runs in the direction of the longest side of the battery and the transverse axis 36 runs in the direction of the central extent of the battery 5. The shortest extent of the battery 5 is parallel to the central plane 41 and aligned vertically in the operating position 20. The vertical axis 57 of the battery 5 is also shown in FIG. 3. The longitudinal axis 35, the transverse axis 36 and the vertical axis 57 run perpendicularly to one another and advantageously form the main axes of the battery 5.

At the intake opening 8, the blower tube 2 has a width e, measured perpendicular to the central plane 41, and a height f, measured parallel to the central plane 41, preferably vertically. As shown in FIG. 7, the height f is significantly smaller than the width e. The width e is advantageously at least 110%, in particular at least 130%, preferably at least 150%, of the height f. In the embodiment, the width e is approximately 180% to approximately 220% of the height f. The height f and the width e are preferably configured, starting from the intake opening 8 to the entry into the blower unit 3, in such a way that the flow cross section of the blower tube 2 is approximately constant. This makes it easy to achieve a favorable spatial arrangement and compact configuration with low flow resistance in the blower tube 2.

FIG. 8 shows the locking unit 45 for the battery 5 in detail. The locking unit 45 comprises a pivot lever 47, which is arranged between the battery 5 and the blower tube 2 in a cavity formed by the bulge 48. The pivot lever 47 is advantageously mounted in a spring-loaded manner and locks the battery 5 in the unactuated position shown in FIG. 8. If the pivot lever 47 is actuated by the operator, the battery 5 is unlocked and can be removed from the housing 21 by the operator for charging or replacement. The locking unit 45 is arranged between battery 5 and blower tube 2. This results in a space-saving arrangement.

In order to keep the sound generation, in particular in the intake section 29, low, the intake section may be formed in the manner of a Helmholtz resonator. For this purpose, it is preferably provided that the blower tube has at least one opening, preferably a multiplicity of openings on the circumference. Two such openings 60 are shown schematically and by way of example in FIG. 5. A cavity 61, into which the openings 60 open, is formed on the outer side of the blower tube 2. This defined air volume connected to the blower tube 2 is preferably configured such that the sound generated in the blower tube 2 is reduced.

In the embodiment, the electric motor 4 is arranged inside the blower unit 3. Alternatively, it may be provided that the electric motor 4 is arranged at a different location, preferably outside the blower tube 2.

It is understood that the foregoing description is that of the preferred embodiments of the invention and that various changes and modifications may be made thereto without departing from the spirit and scope of the invention as defined in the appended claims.

1. A handheld blower apparatus comprising:
a handle for guiding the blower apparatus during operation;
a blower tube;
a blower unit arranged in said blower tube;
wherein the blower apparatus defines an intake opening and a discharge opening;
said blower unit having at least one blower wheel configured to be driven rotationally about a rotational axis, the rotational axis being aligned in a direction of an air flow flowing out from said at least one blower wheel during operation;
an electric motor configured to drive said at least one blower wheel;
a battery configured to supply said electric motor with energy;
wherein said battery and said handle are arranged on opposite sides of said blower tube and a handle opening extends between said handle and said blower tube;
the blower apparatus defining a central plane, which intersects said handle and said battery and which contains said rotational axis of said blower wheel;
said handle opening having a length (g) measured parallel to said rotational axis; and,
said blower tube having a top side which, when viewed in a direction perpendicular to said central plane, has an indentation extending over at least 50% of said length (g).

2. The blower apparatus of claim 1, wherein, in at least one intersecting plane which intersects said handle opening and is perpendicular to said rotational axis of said blower wheel, a distance (a) of said rotational axis of said blower unit from said top side of said blower tube running adjacent to said handle opening is smaller than a distance (b) of said rotational axis from an opposite bottom side of said blower tube.

3. The blower apparatus of claim 1, wherein, in at least one intersecting plane which intersects said handle opening and is perpendicular to said rotational axis, a width (e), measured perpendicular to said central plane, of said blower tube is greater than a height (f), measured in the central plane, of the blower tube in said intersecting plane.

4. The blower apparatus of claim 1, wherein said battery defines a longitudinal axis running parallel to said central plane.

5. The blower apparatus of claim 1, wherein, when viewed in the direction perpendicular to said central plane, a longitudinal center axis of said blower tube in said discharge opening encloses an angle (β) lying in a range of 120° to 175° with said rotational axis of said blower wheel.

6. The blower apparatus of claim 5, wherein the angle (β), when viewed in the direction perpendicular to said central plane, lies in a range of 140° to 170°.

7. The blower apparatus of claim 1, wherein a distance (a′) of said top side of said blower tube from said rotational axis at said intake opening is greater than a distance (b′) of a bottom side of said blower tube from said rotational axis.

8. The blower apparatus of claim 1, wherein said battery defines a longitudinal axis which encloses an angle (γ) of more than 2° with said rotational axis of said blower wheel, wherein said angle (γ) opens in said blower tube counter to said air flow direction.

9. The blower apparatus of claim 1 further comprising:
a housing;
a mechanical locking unit arranged at least partially between said battery and said blower tube and having an actuating element;
said battery being held on said housing via said mechanical locking unit; and,
said blower tube having a bulge into which said actuating element projects.

10. The blower apparatus of claim 1, wherein said battery is at a distance (n), measured parallel to said rotational axis of said blower wheel, from said discharge opening, said distance (n) being greater than a distance (m), also measured parallel to said rotational axis of said blower wheel, of said handle opening from said discharge opening.

11. The blower apparatus of claim 1, wherein said electric motor is at a distance (o), measured parallel to said rotational axis of said blower wheel, from said discharge opening, said distance (o) being smaller than a distance (m), also measured parallel to said rotational axis of said blower wheel, of said handle opening from said discharge opening.

12. The blower apparatus of claim 1, wherein a largest distance (c), measured parallel to said rotational axis, of said intake opening from said discharge opening is greater than a distance (d) of an end of said battery, which is remote from said intake opening, from said discharge opening.

13. The blower apparatus of claim 1, wherein said intake opening has a first end-side intake area and a second intake area on a circumference of said blower tube.

14. The blower apparatus of claim 1, wherein, in an operating position, a center of gravity of the work apparatus is disposed under said handle.

15. The blower apparatus of claim 1, wherein said electric motor is arranged in said blower tube.

16. The blower apparatus of claim 1, wherein said electric motor is arranged in an interior of said blower unit.

17. The blower apparatus of claim 1, wherein a maximum distance (k), measured parallel to said rotational axis of said blower wheel, of a side of said electric motor, which is remote from said discharge opening, is not more than 5 centimeters larger than a distance (m), also measured parallel to said rotational axis of said blower wheel, of said handle opening from said discharge opening.

18. The blower apparatus of claim 17, wherein said maximum distance (k), measured parallel to said rotational axis of said blower wheel, of said side of said electric motor, which is remote from said discharge opening, is smaller than said distance (m), also measured parallel to said rotational axis of said blower wheel, of said handle opening from said discharge opening.
